(19) United States
(12) Patent Application Publication
(10) Pub. No.: US 2008/0175653 A1
(43) Pub. Date: Jul. 24, 2008

(54) Document binder that is used easily and conveniently

(76) Inventor: Ken-Jui Su, Taichung Shien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/657,291

(22) Filed: Jan. 24, 2007

(51) Int. Cl. B42F 13/00

(52) U.S. Cl. 402/73

(57) ABSTRACT

A document binder includes an intermediate connecting board mounted between a bottom board and a faceplate. Thus, the intermediate connecting board has a type and a specification that can be changed to make a document binder having different specifications and types, thereby enhancing the versatility of the document binder. In addition, both of the bottom board and the faceplate have a determined specification, so that the manufacturer only needs to change the specification of the intermediate connecting board to make a document binder having different specifications. Further, the document binder consists of the bottom board, the faceplate and the intermediate connecting board which have different colors, types and patterns, thereby enhancing the aesthetic quality of the document binder.

### BACKGROUND OF THE INVENTION

1. Field of the Invention

The present invention relates to a document binder and, more particularly, to a document binder for storing document.

2. Description of the Related Art

A conventional document binder comprises a plastic board having a mediate portion formed with two spaced folding lines to fold the plastic board into two side plates and an intermediate plate located between the side plates, and a clamp mounted in the plastic board and located between the side plates of the plastic board to clamp a document. However, the plastic board has a determined width which is defined by the side plates of the plastic board so that the manufacturer has to make plastic boards of different widths so as to make document binders having different specifications, thereby complicating the process of production, increasing the costs of fabrication, and increasing the wasting material. In addition, the clamp is mounted in the plastic board by rivets which are exposed outwardly from the plastic board, thereby affecting the outer appearance of the document binder. Further, the plastic board only has a single color, types or pattern, thereby decreasing the aesthetic quality of the document binder.

### BRIEF SUMMARY OF THE INVENTION

In accordance with the present invention, there is provided a document binder, comprising a bottom board, a faceplate spaced from the bottom board, and an intermediate connecting board mounted between the bottom board and the faceplate and having a first side formed with a first covering plate mounted on the bottom board, a second side formed with a second covering plate bonded onto the faceplate and a mediate portion formed with two spaced folding lines located between the bottom board and the faceplate to separate the bottom board from the faceplate.

The primary objective of the present invention is to provide a document binder that is used easily and conveniently.

Another objective of the present invention is to provide a document binder, wherein the intermediate connecting board has a type and a specification that can be changed to make a document binder having different specifications and types, thereby enhancing the versatility of the document binder.

A further objective of the present invention is to provide a document binder, wherein both of the bottom board and the faceplate have a determined specification, so that the manufacturer only needs to change the specification of the intermediate connecting board so as to make a document binder having different specifications, thereby simplifying the process of production, saving the costs of fabrication, and reducing the wasting material.

A further objective of the present invention is to provide a document binder, wherein the clamp is hidden between the bottom board and the faceplate and encompassed by the intermediate connecting board, so that the clamp is not exposed outwardly from the document binder, thereby enhancing the outer appearance of the document binder.

A further objective of the present invention is to provide a document binder, wherein the document binder consists of the bottom board, the faceplate and the intermediate connecting board which have different colors, types and patterns, thereby enhancing the aesthetic quality of the document binder.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a document binder in accordance with the preferred embodiment of the present invention.

FIG. 2 is another perspective view of the document binder as shown in FIG. 1.

FIG. 3 is an exploded perspective view of the document binder as shown in FIG. 2.

FIG. 4 is a bottom assembly view of the document binder as shown in FIG. 3.

FIG. 5 is a perspective view of a bottom board of the document binder as shown in FIG. 2.

FIG. 6 is a top operational view of the document binder as shown in FIG. 2.

FIG. 7 is a perspective view of a document binder in accordance with another preferred embodiment of the present invention.

FIG. 8 is an exploded perspective view of the document binder as shown in FIG. 7.

### DETAILED DESCRIPTION OF THE INVENTION

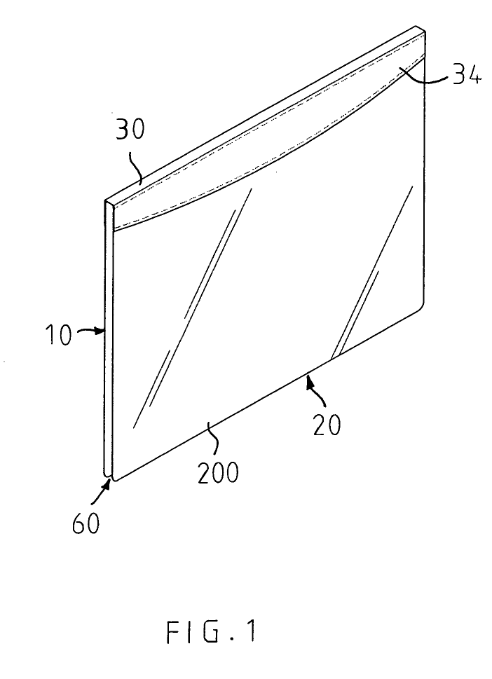

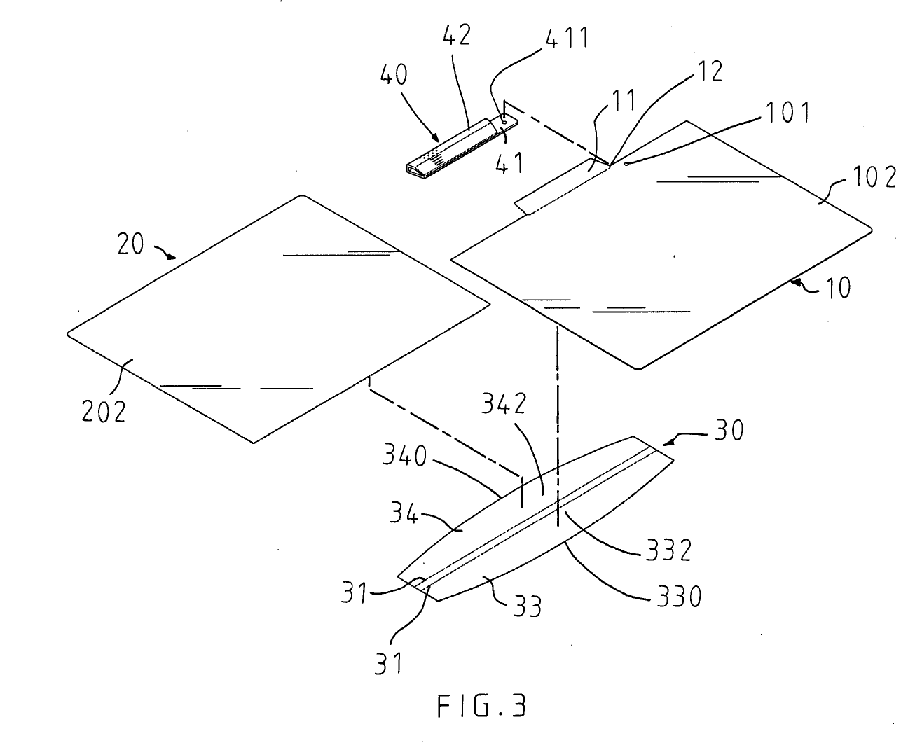

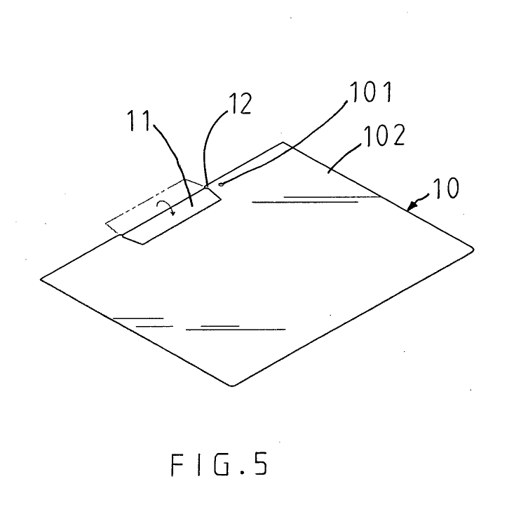

Referring to the drawings and initially to FIGS. 1-5, a document binder in accordance with the preferred embodiment of the present invention comprises a bottom board 10, a faceplate 20 spaced from the bottom board 10, and an intermediate connecting board 30 mounted between the bottom board 10 and the faceplate 20 and having a first side formed with a first covering plate 33 mounted on the bottom board 10, a second side formed with a second covering plate 34 bonded onto the faceplate 20 and a mediate portion formed with two spaced folding lines 31 located between the bottom board 10 and the faceplate 20 to separate the bottom board 10 from the faceplate 20.

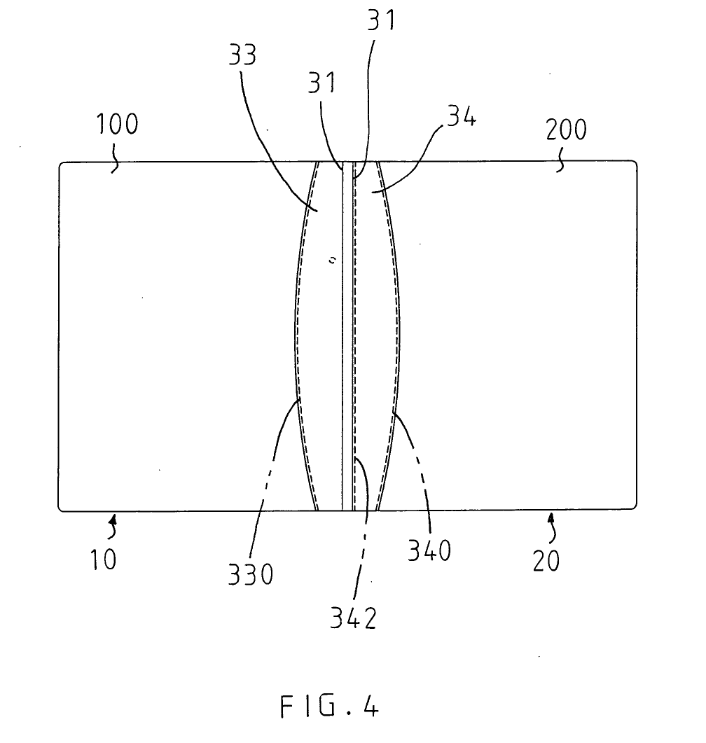

The intermediate connecting board 30 is made of a plastic material. The first covering plate 33 of the intermediate connecting board 30 is mounted on an outer face 100 (see FIG. 4) of the bottom board 10, and the second covering plate 34 of the intermediate connecting board 30 is mounted on an outer face 200 of the faceplate 20. The first covering plate 33 of the intermediate connecting board 30 has an outer edge 330 mounted on the outer face 100 of the bottom board 10 by bonding or stitching as shown in FIG. 4 and an inner edge 332 detached from the outer face 100 of the bottom board 10, and the second covering plate 34 of the intermediate connecting board 30 has an outer edge 340 and an inner edge 342 mounted on the outer face 200 of the faceplate 20 respectively by bonding or stitching as shown in FIG. 4. The first covering plate 33 and the second covering plate 34 of the intermediate connecting board 30 are arranged symmetrically and have different profiles and patterns to enhance the aesthetic quality of the intermediate connecting board 30. The folding lines 31 of the intermediate connecting board 30 are located between the first covering plate 33 and the second covering plate 34. Each of the folding lines 31 of the intermediate connecting board 30 extends in an axial direction of the intermediate connecting board 30 and extends through a whole length of the intermediate connecting board 30. The distance between the folding lines 31 of the intermediate connecting board 30 is equal to that between the bottom board 10 and the faceplate 20 to define a receiving space 60 (see FIG. 1) between the bottom board 10 and the faceplate 20 to receive a document.

The faceplate 20 is made of a plastic material which is translucent or transparent. The faceplate 20 has a specification corresponding to the size of the document.

The bottom board 10 is made of a plastic material which is translucent or opaque. The bottom board 10 has a specification corresponding to the size of the document. The bottom board 10 has a side formed with a movable edge 12 detached from the first covering plate 33 of the intermediate connecting board 30 and formed with a pivot hole 101 located beside the movable edge 12. The movable edge 12 of the bottom board 10 has a mediate portion provided with an outwardly protruding foldable plate 11 that is movable to rest on an inner face 102 of the bottom board 10 to press the document.

The document binder further comprises a clamp 40 pivotally mounted on the movable edge 12 of the bottom board 10 and located between the first covering plate 33 of the intermediate connecting board 30 and an inner face 202 of the faceplate 20. Thus, the clamp 40 is hidden between the bottom board 10 and the faceplate 20 and encompassed by the intermediate connecting board 30 without being exposed outwardly from the bottom board 10, the faceplate 20 and the intermediate connecting board 30 as shown in FIG. 1, thereby enhancing the outer appearance of the document binder. The clamp 40 is made of a plastic material and has a bottom plate 41 pivotally mounted on the movable edge 12 of the bottom board 10 and rested on the outer face 100 (see FIG. 4) of the bottom board 10 and a flexible clamping plate 42 pivotally mounted on the bottom plate 41 and rested on the inner face 102 of the bottom board 10 so that the movable edge 12 of the bottom board 10 is clamped between the bottom plate 41 and the clamping plate 42 of the clamp 40. Preferably, the clamping plate 42 of the clamp 40 is rested on the foldable plate 11 of the bottom board 10 when the foldable plate 11 of the bottom board 10 is rested on the inner face 102 of the bottom board 10. The bottom plate 41 of the clamp 40 has a distal end formed with a pivot bore 411 pivotally mounted on the pivot hole 101 of the bottom board 10 by a pivot pin 44.

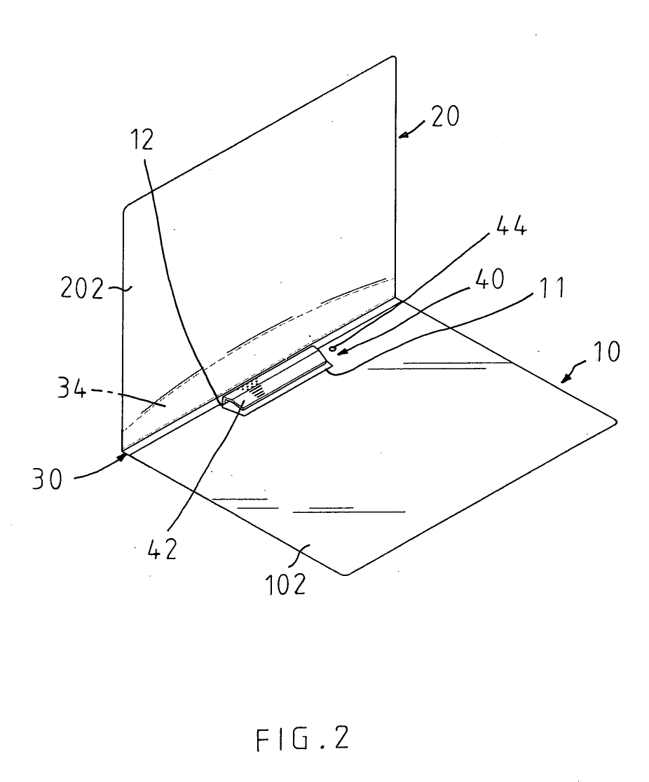

As shown in FIG. 2, the clamp 40 is pivoted relative to the bottom board 10 to a first position where the bottom plate 41 of the clamp 40 is rested on the outer face 100 (see FIG. 4) of the bottom board 10 and the clamping plate 42 is rested on the foldable plate 11 of the bottom board 10, so that the movable edge 12 and the foldable plate 11 of the bottom board 10 are clamped between the bottom plate 41 and the clamping plate 42 of the clamp 40, and the document (not shown) pressed by the foldable plate 11 of the bottom board 10 is clamped by the bottom plate 41 and the clamping plate 42 of the clamp 40.

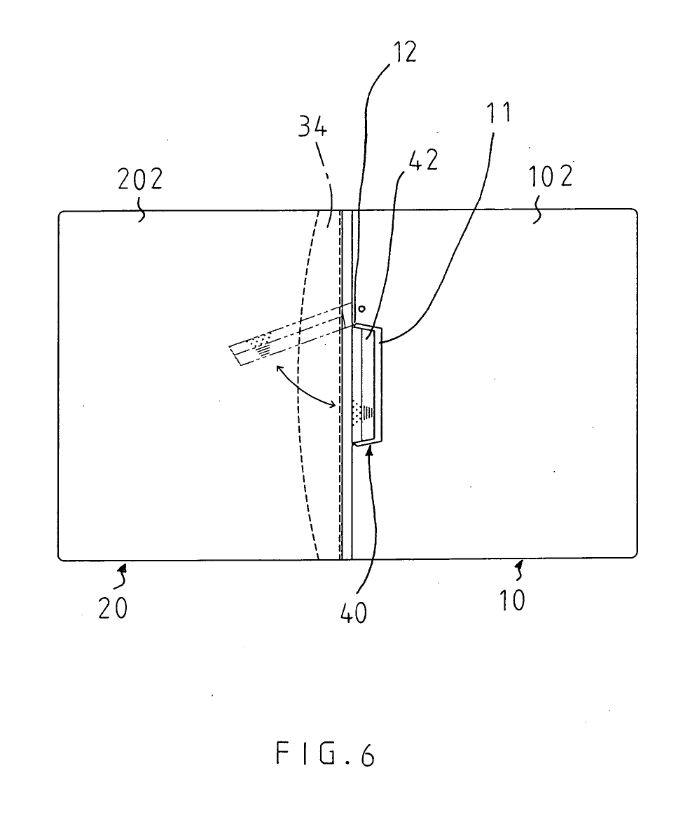

As shown in FIG. 6, the clamp 40 is pivoted relative to the bottom board 10 to a second position where the clamp 40 is detached from the movable edge 12 of the bottom board 10 and is rested on the inner face 202 of the faceplate 20 to release the movable edge 12 and the foldable plate 11 of the bottom board 10 so as to release the document from the clamp 40.

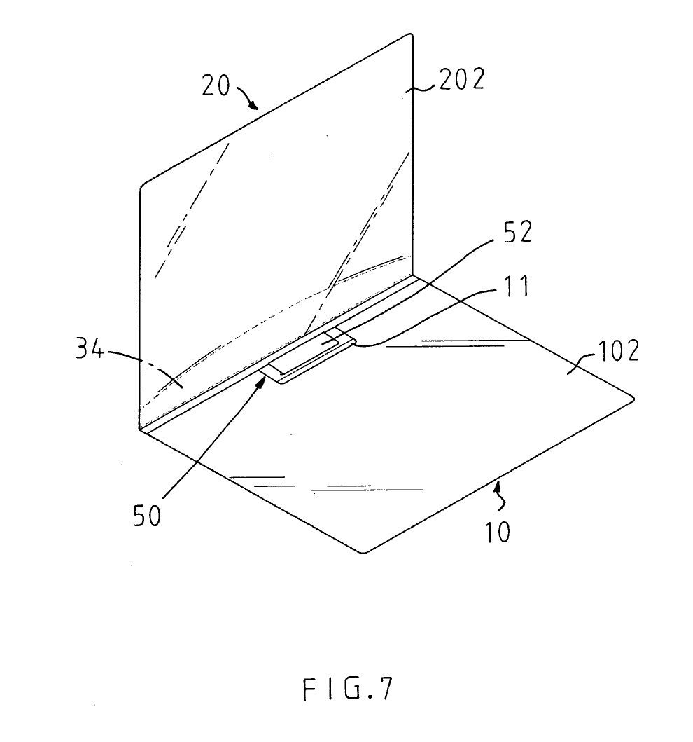

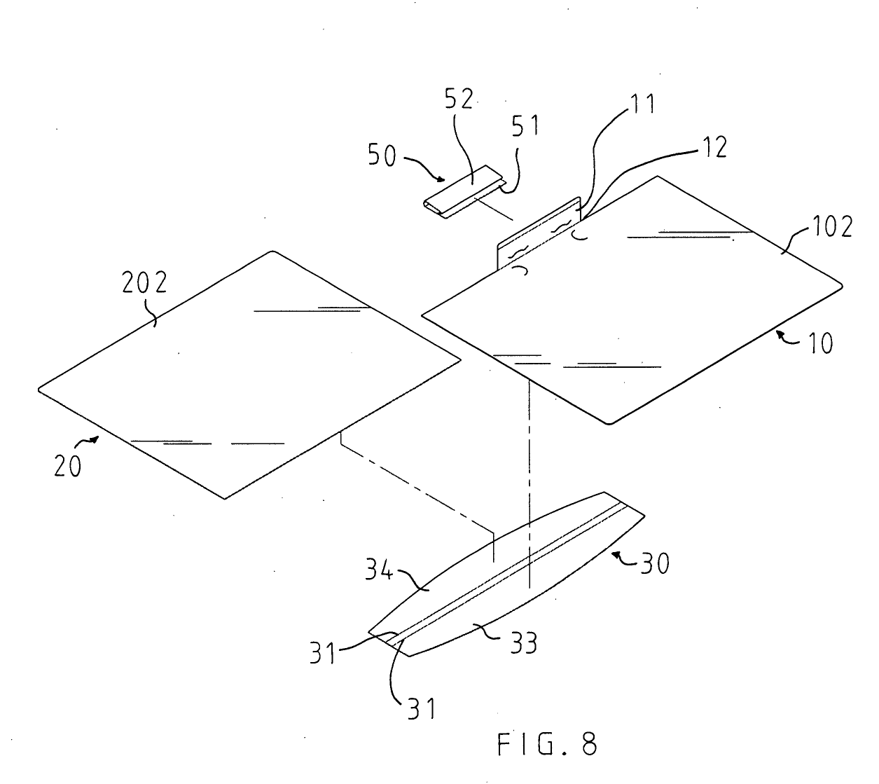

Referring to FIGS. 7 and 8, the document binder further comprises a clamp 50 movably mounted on the movable edge 12 of the bottom board 10. The clamp 50 is made of a plastic material and has a bottom plate 51 and a flexible clamping plate 52. Thus, the clamp 50 is movable on a connection of the foldable plate 11 and the movable edge 12 of the bottom board 10 to clamp the document (not shown) pressed by the foldable plate 11 of the bottom board 10.

Accordingly, the intermediate connecting board 30 has a type and a specification that can be changed to make a document binder having different specifications and types, thereby enhancing the versatility of the document binder. In addition, both of the bottom board 10 and the faceplate 20 have a determined specification, so that the manufacturer only needs to change the specification of the intermediate connecting board 30 so as to make a document binder having different specifications, thereby simplifying the process of production, saving the costs of fabrication, and reducing the wasting material. Further, the clamp 40 is hidden between the bottom board 10 and the faceplate 20 and encompassed by the intermediate connecting board 30, so that the clamp 40 is not exposed outwardly from the document binder, thereby enhancing the outer appearance of the document binder. Further, the document binder consists of the bottom board 10, the faceplate 20 and the intermediate connecting board 30 which have different colors, types and patterns, thereby enhancing the aesthetic quality of the document binder.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A document binder, comprising:
a bottom board;
a faceplate spaced from the bottom board;
an intermediate connecting board mounted between the bottom board and the faceplate and having a first side formed with a first covering plate mounted on the bottom board, a second side formed with a second covering plate bonded onto the faceplate and a mediate portion formed with two spaced folding lines located between the bottom board and the faceplate to separate the bottom board from the faceplate.

2. The document binder in accordance with claim 1, wherein the first covering plate of the intermediate connecting board is mounted on an outer face of the bottom board, and the second covering plate of the intermediate connecting board is mounted on an outer face of the faceplate.

3. The document binder in accordance with claim 2, wherein the first covering plate of the intermediate connecting board has an outer edge mounted on the outer face of the bottom board and an inner edge detached from the outer face of the bottom board, and the second covering plate of the intermediate connecting board has an outer edge and an inner edge mounted on the outer face of the faceplate respectively.

4. The document binder in accordance with claim 1, wherein the folding lines of the intermediate connecting board are located between the first covering plate and the second covering plate.

5. The document binder in accordance with claim 1, wherein a distance between the folding lines of the intermediate connecting board is equal to that between the bottom board and the faceplate to define a receiving space between the bottom board and the faceplate.

6. The document binder in accordance with claim 2, wherein the bottom board has a side formed with a movable edge detached from the first covering plate of the intermediate connecting board.

7. The document binder in accordance with claim 6, further comprising a clamp mounted on the movable edge of the bottom board and located between the first covering plate of the intermediate connecting board and an inner face of the faceplate.

8. The document binder in accordance with claim 7, wherein the clamp is hidden between the bottom board and the faceplate and encompassed by the intermediate connecting board without being exposed outwardly from the bottom board, the faceplate and the intermediate connecting board.

9. The document binder in accordance with claim 7, wherein the clamp is pivotally mounted on the movable edge of the bottom board.

10. The document binder in accordance with claim 7, wherein the clamp is movably mounted on the movable edge of the bottom board.

11. The document binder in accordance with claim 7, wherein the clamp has a bottom plate mounted on the movable edge of the bottom board and rested on the outer face of the bottom board and a flexible clamping plate pivotally mounted on the bottom plate and rested on an inner face of the bottom board so that the movable edge of the bottom board is clamped between the bottom plate and the clamping plate of the clamp.

12. The document binder in accordance with claim 11, wherein the movable edge of the bottom board has a mediate portion provided with an outwardly protruding foldable plate that is movable to rest on the inner face of the bottom board to press the document.

13. The document binder in accordance with claim 12, wherein the clamping plate of the clamp is rested on the foldable plate of the bottom board when the foldable plate of the bottom board is rested on the inner face of the bottom board.

14. The document binder in accordance with claim 11, wherein the bottom board is formed with a pivot hole located beside the movable edge, and the bottom plate of the clamp has a distal end formed with a pivot bore pivotally mounted on the pivot hole of the bottom board.

15. The document binder in accordance with claim 12, wherein the clamp is pivoted relative to the bottom board to a first position where the bottom plate of the clamp is rested on the outer face of the bottom board and the clamping plate is rested on the foldable plate of the bottom board, so that the movable edge and the foldable plate of the bottom board are clamped between the bottom plate and the clamping plate of the clamp.

16. The document binder in accordance with claim 15, wherein the clamp is pivoted relative to the bottom board to a second position where the clamp is detached from the movable edge of the bottom board and is rested on the inner face of the faceplate to release the movable edge and the foldable plate of the bottom board.

17. The document binder in accordance with claim 12, wherein the clamp is movable on a connection of the foldable plate and the movable edge of the bottom board.

18. The document binder in accordance with claim 1, wherein the first covering plate and the second covering plate of the intermediate connecting board are arranged symmetrically and have different profiles and patterns.

19. The document binder in accordance with claim 1, wherein each of the folding lines of the intermediate connecting board extends in an axial direction of the intermediate connecting board and extends through a whole length of the intermediate connecting board.

20. The document binder in accordance with claim 1, wherein the bottom board, the faceplate, the intermediate connecting board and the clamp are made of plastic material.
